(19) United States
(12) Patent Application Publication
(10) Pub. No.: US 2012/0015162 A1
(43) Pub. Date: Jan. 19, 2012

(54) RESIN-COATED MATERIAL AND PROCESS FOR MANUFACTURING SAME

(75) Inventors: Alexandre LION, Nuille-sur-Vicoing (FR); Raphael LION, Laval (FR)

(73) Assignee: SOCIETE D'ENDUCTION ET DE FLOCKAGE, Laval (FR)

(21) Appl. No.: 13/165,120

(22) Filed: Jun. 21, 2011

(30) Foreign Application Priority Data
Jun. 22, 2010 (FR) 10 54958

(51) Int. Cl. B32B 5/16; B05D 3/06; B05D 5/00; B32B 37/00; B32B 3/00; B32B 5/02

(52) U.S. Cl. 428/206; 428/327; 442/59; 427/256; 156/60; 427/555

(57) ABSTRACT

A coated material includes a support covered with at least one layer of polymer resin, characterized in that the resin includes heat-expandable microspheres. A process for manufacturing the novel material, and also the use thereof in the binding and packaging fields and an article including the coated material are also described.

### FIELD OF THE INVENTION

The present invention relates to a novel material, produced by coating, intended for the binding and packaging fields. The present invention also relates to the process for manufacturing the novel material, and also to the use thereof and to an article comprising said material.

### PRIOR ART

Many synthetic substances, usually obtained by the coating (process that consists in applying a thin layer of material in fluid or powder form onto a substrate) of polymer resins, have the property of changing colour when they are subjected to thermal marking. These materials are generally based on supports made of paper, of board, or of a non-woven fabric or on textile supports which are covered with one or more layers of polymer resins. Indeed, these materials are obtained by the coating, onto the chosen support, of acrylic or polyurethane resins, in aqueous dispersion or in solution in organic solvents, or else of plastisols based on polyvinyl chloride. The coating may take place directly, by spreading the prepared paste onto the support, or else by the “transfer” method: in this case, the formulated resin, still in the liquid phase, is deposited onto a smooth or grained, non-stick paper, the support is deposited by simple contact onto the layer which has just been coated, and the assembly is heat bonded by passing into a drying tunnel. In the case of a direct coating, a graining of the surface, applied subsequently, may modifier this surface and give it a “veined” design reminiscent of that of natural skin. All these processes are widely known and used.

The industrial products thus manufactured are generally used as covering material in the binding and wrapping industries, and in all applications for decorating a given support, for which it is advisable to modify the appearance and feel.

An additional operation very commonly carried out on these materials is that of thermal marking: a metal tool is machined or cast so that it displays, in relief, the imprint of a graphic design that the user wishes to print in counter-relief, on the surface to be decorated. The tool is brought to a temperature in the vicinity of 120-150° C., depending on the surface to be marked, then is applied with strong pressure, for quite a short time, to the synthetic material. The principle is that of “hot iron stamping”, applied to leathers and skins. A decorative film may be inserted between the heated tool and the material to be decorated: the design pre-printed or deposited on the film is then transferred onto the synthetic material, giving it the appearance of the decorative film. Multicoloured printings, or gold, silver or metallized markings, having innumerable decorative effects, are thus obtained.

The same thermal marking operation, carried out without the use of the decorative film, makes it possible to obtain recessed marking, of the same colour as that of the unmarked material, which often is not sufficiently visible.

It is also possible to have synthetic materials that exhibit the property of changing colour—in general, they become darker—under the action of the heat that is applied thereto during the thermal marking. This property is usually obtained by incorporating pigments into the coated polymer resin, the colour of which pigments is permanently modified when they are heated, or else to have polymer resins that are modified so as to themselves exhibit this property. Under these conditions, that is to say without a decorative film—and therefore less expensively,—a recessed marking having a darker colour than that of the virgin material, and therefore perfectly visible, is obtained. This decorative appearance, obtained by thermal browning of a synthetic material, is very sought after in the binding and graphic industry fields.

However, this technique has the drawback of requiring the manufacture of a tool that reproduces the imprint of the desired design; this tool is expensive, which gives a high price to small production runs and it must be replaced periodically in the case of multiple marking operations. The changeover of the tool on the marking machine is furthermore quite long, due to the temperature reached by the tool. The effect obtained is furthermore still in counter-relief, the decorated material being pushed in during the thermal marking operation.

The objective of the present invention is to provide a novel material that completely or partly avoids the aforementioned drawbacks.

### SUMMARY OF THE INVENTION

For this purpose, one subject of the invention is a coated material comprising a support covered with at least one layer of polymer resin, characterized in that said resin comprises heat-expandable microspheres.

Preferably, the coated material comprises an inner layer of microsphere-free polymer resin.

Advantageously, the coated material comprises an outer layer on which a pattern is formed.

Preferably, the microspheres comprise a polymer shell enclosing a blowing agent capable of expanding said shell under the action of heat.

In particular, the blowing agent is a gas or a liquid with a low boiling point. This agent exhibits the property of inflating under the action of heat and of expanding the shell “like a balloon”. Thus, these microspheres may enlarge by up to forty times relative to their initial size.

Preferably, the support is chosen from: paper, board, a non-woven fabric, a plastic film, a textile support, a woven fabric, a knitted fabric or a mixture thereof.

According to one feature of the invention, said layer of polymer resin is chosen from: an acrylic resin, a polyvinyl chloride resin, a polyurethane resin or a mixture thereof. In particular, said layer of polymer resin also comprises an agent chosen from: a rheological additive, pigments, a matting agent, a silicone-based emulsion or a mixture thereof.

In particular, the invention relates to a coated material comprising a support covered with at least one outer layer of polymer resin comprising heat-expandable microspheres, characterized in that said outer layer comprises at least one polyurethane resin.

Another subject of the present invention is a process for manufacturing a coated material as described above, comprising the steps consisting in:

i) producing at least one layer on a support, via coating, starting from a polymer resin comprising heat-expandable microspheres, so as to obtain a layer of polymer resin comprising said microspheres,

ii) producing on said layer at least one pattern using selective heating means, enabling, via heating and/or pressure, the expansion of said microspheres.

Preferably, step i) comprises the production of an inner layer of microsphere-free polymer resin and of an outer layer of polymer resin comprising said microspheres.

Advantageously, the heating is carried out using a laser beam and/or a heated raised tool.

Generally, the laser is computer-controlled and is usually of the type identical to cutting lasers for flatbed plotters. The laser beam will thus depict the chosen pattern by scanning the support. Whereas the raised tool is generally a metal tool on which the pattern to be reproduced is engraved.

The process according to the invention thus makes it possible to produce, with a raised (metal) tool, or more specifically in the absence of such a tool, a raised or recessed thermal marking, having a colour different to that of the virgin surface. A “two-tone” effect specific to thermally reactive materials is thus obtained. The surface thus marked furthermore has a very pleasant feel.

This solution can moreover be applied to large runs and to small runs. It enables very precise engraving to be obtained and results in completely original graphic effects, opening up multiple novel possibilities in the graphic industry field.

According to a first variant, the heating temperature lies between 120° C. and 130° C., so as to obtain a raised pattern by inflation of the microspheres, or greater than or equal to 150° C., (for example of the order of 150° C.-160° C.), so as to obtain a recessed pattern by collapse or vaporization of the layer of resin comprising the expandable microspheres.

In a first variant of the invention, it is possible to depict patterns on an outer layer of polymer resin comprising the expandable microspheres, using a machined or cast, raised metal tool, as is conventionally carried out today.

According to a second variant, a laser beam is used to obtain this graphic effect, the adjustment of the power of the beam making it possible either to obtain a raised pattern by inflation of the microspheres, or to obtain a recessed engraving by vaporization of the layer of resin comprising the expandable microspheres. These various adjustments make it possible to obtain suitable temperatures in order to enable either an inflation of the microspheres, or a vaporization of the outer layer.

Thus, the power and the scanning speed of the beam may be adjusted so that the temperature attained by the coated resin during the passage of the beam triggers the expansion of the microspheres. This operation gives rise to an inflation of the part touched by the beam, with great precision, and the scanned surface is converted to a foam having a much paler colour than the part of the resin left intact, and an extremely soft feel, reminiscent of that of a suede leather skin. Or else, a different adjustment of the power of the laser beam makes it possible to vaporize the surface layer (outer layer), and to hollow it out deep down until a coated layer (inner layer), generally of different colour, printing and/or material and that is located under the first layer, is revealed: it is thus possible to selectively reveal, according to a given design, an inner layer having a colour or an appearance that is totally different from that of the outer surface.

The programming of the laser beam scanning thus makes it possible to combine, on one and the same coated material, a recessed or raised thermal marking. Firstly, it is possible to obtain a marking with a heated tool, then to subsequently obtain on other parts of the coated material a raised or recessed marking by programmed scanning of a laser beam.

One objective of the present invention also relates to a product or article comprising the aforementioned coated material.

Another objective of the present invention relates to the use of a coated material as described above for wrapping, packaging or binding products or articles.

### DESCRIPTION OF THE INVENTION

The invention will be better understood, and other objectives, details, features and advantages thereof will appear more clearly, in the course of the following description of one particular embodiment of the invention and of illustrative examples, given solely by way of illustration and non-limitingly, in reference to the appended drawings.

In these drawings:

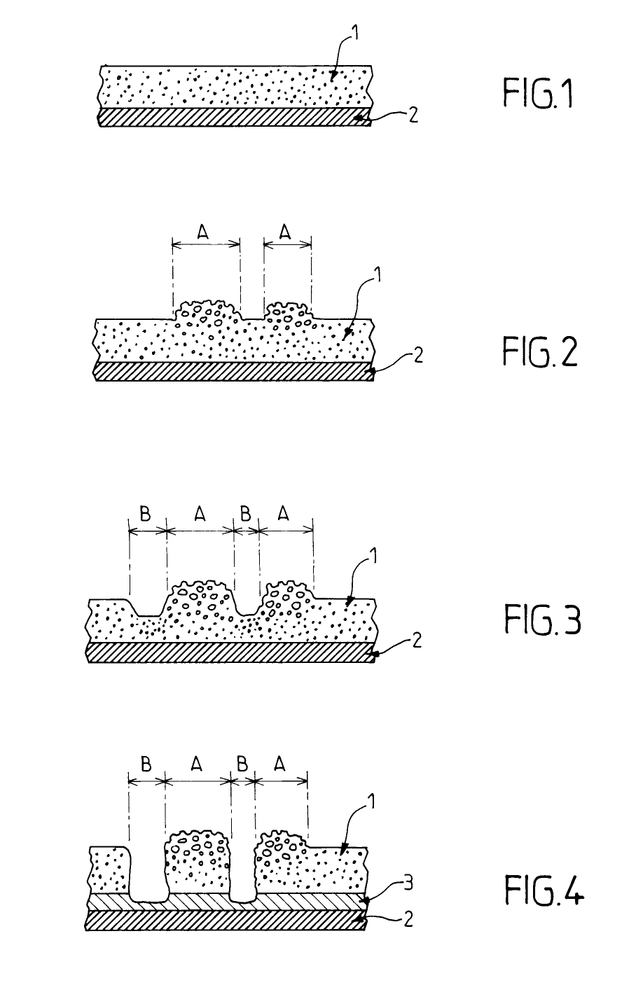

FIG. 1 represents a longitudinal cross-sectional view of a coated material according to one embodiment of the present invention comprising a support covered with a single layer of polymer resin comprising microspheres;

FIG. 2 represents a longitudinal cross-sectional view of the material from FIG. 1 after raised marking;

FIG. 3 represents a longitudinal cross-sectional view of the material from FIG. 2 after recessed marking;

and FIG. 4 represents a longitudinal cross-sectional view of a coated material according to one embodiment variant in which the material comprises a support covered with a first layer referred to as an inner layer, which is free of microspheres and is itself covered with a second layer, referred to as an outer layer, the latter layer comprising microspheres.

In order to obtain the coated material according to the present invention, one or more direct or transfer coating operations is or are carried out on a support of any nature, such as paper, board, a non-woven fabric, a plastic film or a textile, woven or knitted support. Each coating operation makes it possible to produce one layer. Thus several coating operations make it possible to produce several layers which are superposed on one another. For example, in FIGS. 1 to 3, a coating operation was carried out in order to obtain a layer 1 on a support 2 whereas in FIG. 4 two coating operations were carried out in order to obtain an inner layer 3 and an outer layer 1, the inner layer 3 being subjacent to the outer layer 1. In the case of a woven or non-woven support 2, a support 2 covered with a coagulated polyurethane coating is preferably used. Indeed, this polymer resin gives the final product a softer feel. Within the context of the present invention, the outer layer 1 of the coated material comprises heat-expandable microspheres.

This outer layer 1 may be made from synthetic resins of any type:

acrylic, polyvinyl chloride, etc., these resins possibly being in aqueous dispersion or in organic solution. In one preferred aspect of the invention, polyurethane resins are used. Specifically, they give the coated outer layer 1 a soft and slippery feel, reminiscent of that of natural leather. This polyurethane resin is preferably in aqueous dispersion, for ecological reasons, and more advantageously still, it is mixed with an acrylic resin in order to lower the production cost and in particular the resin formulation cost. For example, the resin is prepared for the coating by chemical thickening, and its viscosity is brought to the value suitable for the coating device used (knife over roll, reverse roll, rotary machine, etc.). Generally a viscosity close to 500 poise is desired. The formulation of the resin is also pigmented with the desired colour by addition of colorants suitable for the formula. Finally, before coating, a certain amount of the aforementioned expandable microspheres is incorporated into the formula.

By way of example, one formulation for the outer layer 1 is produced using a polyurethane resin in aqueous dispersion, cut with 10% of acrylic resin.

These two resins are thickened by addition of a rheological additive. Next, this formulation is pigmented with pigments compatible with the aqueous dispersion, such as the pigments from the company DYSTAR. A matting agent is then added, and also an emulsion of silicones that aims to improve the feel of the coating. Finally, thermally-reactive microspheres compatible with aqueous emulsions, for example EXPANCEL® from the company AKZO NOBEL or DUALITE® from the company HENKEL, are added so as to represent around 25% to 50%, and preferably of the order of 40% of the formulation of the outer layer. These microspheres are chosen from the category compatible with the aqueous dispersions, for example EXPANCEL® WU from AZKO NOBEL. In particular, the microspheres could have a dimension of less than 30 microns, such as of the order of 5 to 30 microns with an expansion initialization temperature of the order of 120 to 140° C. Thus an outer layer having a thermally-reactive surface is obtained.

According to a first embodiment, this surface is then engraved by scanning a computer-controlled laser beam. Firstly, the design/pattern to be reproduced is digitized and the corresponding file is introduced into the computer controlling the laser. By way of example, the laser used is a “plotter” type machine from the company GCC, with the reference SPIRIT® having a maximum power of 25 W. When this laser is adjusted to a power of the order of 5 W to 6.2 W, that is to say to quite a low power (making it possible to obtain a temperature of the order of 120-130° C.), the passage of the beam then causes, at the precise location of contact with the coated surface, the expansion of the microspheres contained in the layer of synthetic resin, thus giving rise to a raised marking A (FIGS. 2 to 4) reproducing the digitized design/pattern. This effect is represented in particular in FIG. 2. The expansion of the microspheres converts the coated resin into foam, and greatly changes its colour, which retains the same shade but becomes much lighter due to the expansion of the surface. Thus the “two-tone” effect desired in this type of thermal marking is achieved. This expansion of the coated outer layer also modifies the feel thereof. In the case of a coated polyurethane resin, a soft and pleasant feel, highly reminiscent of that of a suede leather skin, is obtained.

When the laser is adjusted to a power of the order of 20 W to 25 W, that is to say to quite a high power (making it possible to obtain a temperature greater than or equal to 150-160° C.), the passage of the beam no longer causes an inflation of the microspheres, but a vaporization at the surface of the outer layer, creating recesses B, as illustrated in FIG. 3. It should be noted that too powerful a thermal effect destroys the material, whilst too weak an effect causes insufficient expansion.

The marking of the design/pattern also depends on the scanning speed of the beam: the faster the speed, the weaker the localized thermal effect is. Indeed the speed must be sufficient to enable the material to heat up. Thus, depending on the parametrization of the power and of the scanning speed, a person skilled in the art will be able to refine the marking in relief and in counter-relief. Other parameters also make it possible to refine the marking, such as the nature of the coating prepared, the scanning characteristics (specifically, the more lines that are scanned to form an image, the finer and more precise this image will be), and also the position of the focal length of the beam relative to the surface of the outer layer: the effect is at a maximum and is precise with a focal length positioned on the surface (outer layer) to be engraved, and it is diminished and more “hazy” in the opposite case. Preferably, the focussing of the beam is slightly off-centre relative to the surface to be marked: a deviation of 2 to 4 mm This makes it possible to reduce the thermal effect and to avoid burning the coated layer.

The machine described above comprises a laser controlled by a plotter, the operation of which is similar to that of a flatbed plotter. However, it is also possible to use much faster “galvo” lasers, in which the displacement of the laser beam is controlled by a set of moveable mirrors, and no longer by the mechanical displacement of a carrier arm.

It is also possible to use a laser beam for which the displacement is subject to an optical guidance system: an optical sensor detects, on the surface to be marked, guide marks which have been printed thereon, and the laser carries out its engraving work by orienting itself relative to a pre-existing printed design. This possibility finds an application in the case where the outer surface of the synthetic resin containing the microspheres has been printed before being subjected to the laser beam. This printing may be of any type: screen printing, offset printing or hot stamping via the conventional process (heated tool and presence, or absence, of a decorative film). In this case, a chosen pattern is printed or subjected to hot stamping under pressure, transferring to the printed surface, in a first step, guide marks that can be read by an optical sensor. In a second step, the printed surface is placed on a laser machine equipped with an optical guidance system. Next, the parts of the printed pattern that the user desires to be raised by inflating the microspheres are selectively subjected to the action of the laser beam in order to be activated. If the user desires a recessed marking, the same procedure is followed except that the power of the laser is increased. Thus, a decorated surface, combining a printed effect or a recessed thermal marking, and parts of the pattern which appear in relief, in two colours different from that of the original surface (FIG. 3) is obtained.

In a second variant of the invention, a coated material composed of at least two different layers is obtained (FIG. 4), that is to say that it comprises an outer layer comprising the expandable microspheres and an inner layer, which is subjacent to the outer layer and is free of microspheres. The inner layer may be of the same chemical nature as the surface layer, but it generally has a different colour or appearance: it may be coloured, printed or metallized. The features of the laser beam—and more particularly its power—are adjusted for a given design as a function of the desired effect: the beam will thus scan the design to be produced with a power that varies depending on the parts selected. Over certain parts, the power will be suitable for inflating the microspheres contained in the surface layer, and a raised pattern will be obtained, whereas over other parts of the same pattern, scanned by a beam of higher power, the outer layer will be vaporized so as to reveal, without piercing through it, the inner layer.

Exemplary embodiment of this variant: Coated onto a 90 g/m² latex-saturated paper support is an inner layer made of polyurethane, with GOLD pigmentation, of 50 g/m², itself covered with an outer layer made of polyurethane, with BROWN pigmentation, containing the microspheres, of 75-80 g/m². Using the aforementioned laser beam, the raised parts (A) were obtained by scanning at 25% of the power and 100% of the speed, whereas the recessed parts (B), which reveal the subjacent golden layer, were obtained by scanning at 100% of the power and 50% of the speed. During the marking, the beam was defocused by 0.8 cm relative to the surface to be engraved.

The effect thus obtained, in a single pass and with no machined metal tool, combines raised zones having a lighter colour than that of the virgin surface layer, and recessed engraved zones, on which the different appearance and different colour of the subjacent layer become visible. Of course, these two recessed and raised effects may be obtained independently of one another.

Finally, it is also possible to produce the raised or recessed marking by means of conventional metal tools known to a person skilled in the art, such as a machined or cast, raised metal tool. The presence of microspheres makes it possible to obtain a recessed or raised marking effect depending on the temperature of the heated tool: at a low temperature, in the vicinity of 120-130° C., the parts of the surface layer brought into contact with the reliefs of the heated tool will have, after marking, a “raised” inflation and a lighter colour than that of the initial surface; at a higher temperature, greater than or equal to 150-160° C., the effect obtained will be that of a conventional recessed marking, the inflation of the microspheres being counteracted by the application of the heated tool. In this second case, the use, for example, of an intermediate, coloured or metallized, hot-marking film makes it possible to obtain the effect conventionally obtained with this type of application.

It is obviously possible to combine, on one and the same pattern, a “recessed” thermal marking produced firstly with a heated tool, and to subsequently produce, on other parts of the design, a raised or recessed marking by programmed scanning of a laser beam.

Although the invention has been described in connection with several particular embodiments, it is very obvious that it is in no way limited thereto and that it includes all the equivalent techniques of the means described and also combinations thereof if these fall within the scope of the invention.

1. Coated material comprising a support covered with at least one layer of polymer resin, characterized in that said resin comprises heat-expandable microspheres.

2. Coated material according to claim 1, comprising at least one inner layer of microsphere-free polymer resin.

3. Coated material according to claim 1, comprising an outer layer on which a pattern is formed.

4. Coated material according to claim 1, in which the microspheres comprise a polymer shell enclosing a blowing agent capable of expanding said shell under the action of heat.

5. Coated material according to claim 4, in which the blowing agent is a gas or a liquid with a low boiling point.

6. Material according to claim 1, in which the support is chosen from: paper, board, a non-woven fabric, a plastic film, a textile support, a woven fabric, a knitted fabric or a mixture thereof.

7. Material according to claim 1, in which said layer of polymer resin is chosen from: an acrylic resin, a polyvinyl chloride resin, a polyurethane resin or a mixture thereof.

8. Coated material according to claim 7, in which said layer of polymer resin also comprises an agent chosen from: a rheological additive, pigments, a matting agent, a silicone-based emulsion or a mixture thereof.

9. Process for manufacturing a coated material according to claim 3, comprising the steps consisting in:
i) producing at least one layer on a support, via coating, starting from a polymer resin comprising heat-expandable microspheres, so as to obtain a layer of polymer resin comprising said microspheres,
ii) producing on said layer at least one pattern using selective heating means, enabling, via heating and/or pressure, the expansion of said microspheres.

10. Manufacturing process according to claim 9, in which step i) comprises the production of an inner layer of microsphere-free polymer resin and of an outer layer of polymer resin comprising said microspheres.

11. Manufacturing process according to claim 9, in which the heating is carried out using a laser beam and/or a heated raised tool.

12. Manufacturing process according to claim 9, in which the heating temperature lies between 120° C. and 130° C., so as to obtain a raised pattern by inflation of the microspheres, or greater than or equal to 150° C., so as to obtain a recessed pattern by vaporization of the layer of resin comprising the expandable microspheres.

13. Product or article comprising the coated material according to claim 1.

14. Method of wrapping an article, which comprises wrapping the article with a coated material according to claim 1.

15. Coated material according to claim 2, comprising an outer layer on which a pattern is formed.

16. Manufacturing process according to claim 11, in which the heating is carried out using a laser beam and/or a heated raised tool.

17. Manufacturing process according to claim 10, in which the heating temperature lies between 120° C. and 130° C., so as to obtain a raised pattern by inflation of the microspheres, or greater than or equal to 150° C., so as to obtain a recessed pattern by vaporization of the layer of resin comprising the expandable microspheres.

18. Manufacturing process according to claim 11, in which the heating temperature lies between 120° C. and 130° C., so as to obtain a raised pattern by inflation of the microspheres, or greater than or equal to 150° C., so as to obtain a recessed pattern by vaporization of the layer of resin comprising the expandable microspheres.
